(19) United States
(12) Patent Application Publication
(10) Pub. No.: US 2016/0302286 A1
(43) Pub. Date: Oct. 13, 2016

(54) USER TERMINAL APPARATUS, EXTERNAL DEVICE, AND METHOD FOR OUTPUTTING AUDIO

(71) Applicant: SAMSUNG ELECTRONICS CO., LTD., Suwon-si (KR)

(72) Inventors: Ji-hyae KIM, Seoul (KR); Jung-geun KIM, Suwon-si (KR); Yong-jin SO, Seongnam-si (KR); Won-min CHOI, Seoul (KR); Jea-hun HYUN, Yongin-si (KR)

(73) Assignee: SAMSUNG ELECTRONICS CO., LTD., Suwon-si (KR)

(21) Appl. No.: 15/094,611

(22) Filed: Apr. 8, 2016

(30) Foreign Application Priority Data
Apr. 8, 2015 (KR) 10-2015-0049521

(51) Int. Cl. H05B 37/02; G06F 3/16; G06F 3/14; G06K 9/46; H04R 1/02; H04R 3/00

(52) U.S. Cl. CPC H05B 37/0236; H04R 1/028; H04R 3/00; G06F 3/1407; G06K 9/4652; G06F 3/16

(57) ABSTRACT

A user terminal apparatus includes a display unit; a storing unit configured to store audio data; a communication unit configured to transmit the stored audio data to an external device to output the stored audio data from the external device; and a processor configured to extract color information from image data and control the communication unit so that the extracted color information is transmitted to the external device to turn on a lighting according to the extracted color information.

### CROSS-REFERENCE TO RELATED APPLICATIONS

This application claims priority from Korean Patent Application No. 10-2015-0049521, filed on Apr. 8, 2015, in the Korean Intellectual Property Office, the disclosure of which is incorporated herein by reference in its entirety.

### BACKGROUND

1. Field

Apparatuses and methods consistent relate to an apparatus for outputting audio, and more particularly, to a user terminal apparatus, an external device, and a method for outputting audio that provide an interior effect suited to a use environment in which the audio is output.

2. Description of the Related Art

A Bluetooth speaker that transmits and outputs audio files stored in a terminal apparatus such as a smart phone or a tablet PC to a speaker has recently been highlighted.

The Bluetooth speaker connects the terminal apparatus and the speaker to each other according to a Bluetooth communication standard. In addition, according to a Bluetooth standard, the terminal apparatus transmits an audio signal packet to the speaker, and the speaker outputs the received audio signal.

The Bluetooth speaker is very popular because a user located at a local region may simply output music stored in the terminal apparatus through the speaker.

If a wireless audio outputting system also provides an interior effect, such as lighting, suited to a use environment in which an audio is output, a degree of satisfaction of a user will be further increased.

### SUMMARY

Exemplary embodiments overcome the above disadvantages and other disadvantages not described above. Also, the embodiments are not required to overcome the disadvantages described above, and an exemplary embodiment may not overcome any of the problems described above.

The embodiments provide a user terminal apparatus, an external device, and a method for outputting audio that may provide an interior effect according to a use environment in which the audio is output.

According to an aspect, a user terminal apparatus includes a display unit; a storing unit configured to store audio data; a communication unit configured to transmit the stored audio data to an external device to output the stored audio data from the external device; and a processor configured to extract color information from image data and control the communication unit so that the extracted color information is transmitted to the external device to turn on a lighting according to the extracted color information.

The processor may extract dominant color information from the image data and control the communication unit so that the extracted dominant color information is transmitted to the external device to turn on the lighting according to the extracted dominant color information.

The user terminal apparatus may further include a photographing unit configured to photograph a subject to generate the image data.

The image data may be at least one of an album image, a music video image, and an artist image related to the audio data.

The processor may detect audio pattern information from the audio data and control the communication unit so that the detected audio pattern information is transmitted to the external device to turn on the lighting according to the detected audio pattern information.

The processor may control the communication unit so that meta data of the audio data is transmitted to the external device.

The meta data of the audio data may include at least one of music genre information, artist information, beat information, and language information of the audio data.

The external device may be an audio device or a display apparatus.

According to another aspect, an external device includes: a lighting unit; a communication unit configured to receive audio data and color information of image data from a user terminal apparatus; an audio outputting unit configured to output the received audio data; and a processor configured to control the lighting unit so that a lighting is turned on based on the received color information.

The color information may be dominant color information extracted from the image data by the user terminal apparatus, and the processor may control the lighting unit so that a lighting corresponding to the received dominant color information is turned on.

The processor may control the lighting unit so that the lighting corresponding to at least one of a music genre, an artist, a beat, and a language of the received audio data is turned on.

The communication unit may further receive pattern information of the audio data, and the processor may control the lighting unit so that a lighting corresponding to the received pattern information and color information is turned on.

The external device may further include a display unit, wherein the processor controls the display unit so that an image corresponding to the received color information is displayed.

The communication unit may further receive pattern information of the audio data, and the processor may control the display unit so that an image corresponding to the pattern information of the received audio data and the color information is displayed.

According to another aspect, a method for outputting audio includes: transmitting audio data to an external device; extracting color information from image data; and transmitting the extracted color information to the external device.

The extracting of the color information from the image data may include extracting dominant color information from the image data, and the transmitting of the extracted color information to the external device may include transmitting the extracted dominant color information to the external device to turn on the lighting according to the extracted dominant color information.

The method may further include photographing a subject to generate the image data.

The image data may be at least one of an album image, a music video image, and an artist image related to the audio data.

The method may further include transmitting meta data of the audio data to the external device.

The meta data of the audio data may include at least one of music genre information, artist information, beat information, and language information of the audio data.

The external device may be an audio device or a display apparatus.

According to another aspect, a method for outputting audio includes: receiving audio data and color information of image data from a user terminal apparatus; outputting the received audio data; and turning on a lighting based on the received color information.

The color information may be dominant color information extracted from the image data by the user terminal apparatus, and in the turning on of the lighting, a lighting corresponding to the received dominant color information may be turned on.

In the turning on of the lighting, the lighting corresponding to at least one of a music genre, an artist, a beat, and a language of the received audio data may be turned on.

The method may further include receiving pattern information of the audio data, and in the turning on of the lighting, a lighting corresponding to the received pattern information and color information may be turned on.

The method may further include displaying an image corresponding to the received color information.

According to another aspect a non-transitory computer readable storage medium storing a program having a method, the method including receiving audio data and color information of image data from a user terminal apparatus, outputting received audio data and turning on lighting based on received color information.

According to the various exemplary embodiments as described above, the user terminal apparatus, the external device, and the method for outputting audio that may provide the interior effect suited to the use environment in which the audio is output may be provided.

Additional and/or other aspects and advantages will be set forth in part in the description which follows and, in part, will be obvious from the description, or may be learned by practice of the embodiments.

### BRIEF DESCRIPTION OF THE DRAWING FIGURES

The above and/or other aspects will be more apparent by describing certain exemplary embodiments with reference to the accompanying drawings, in which:

FIG. 1 is a schematic diagram of an audio system according to an exemplary embodiment;

FIG. 2 is a block diagram illustrating a configuration of a user terminal apparatus according to an exemplary embodiment;

FIG. 3 is a block diagram illustrating a configuration of an external device according to an exemplary embodiment;

FIG. 4 is a schematic diagram of an audio system according to another exemplary embodiment;

FIG. 5 is a block diagram illustrating a configuration of an external device according to another exemplary embodiment;

FIG. 6 is a schematic diagram of an audio system according to still another exemplary embodiment; and

FIGS. 7 and 8 are flow charts of a method for outputting audio according to an exemplary embodiment.

### DETAILED DESCRIPTION OF THE EXEMPLARY EMBODIMENTS

The embodiments will become apparent by describing exemplary embodiments in detail with reference to the accompanying drawings. For reference, when it is determined that the detailed description of the known function or configuration may obscure the gist of the embodiments in describing them, the detailed description thereof will be omitted.

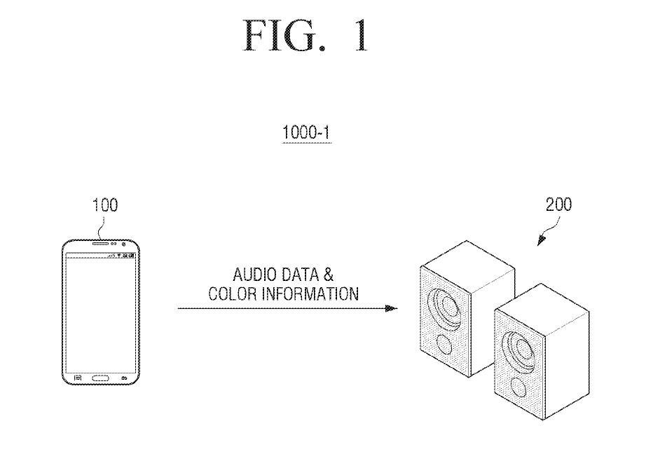

FIG. 1 is a schematic diagram of an audio system 1000-1 according to an exemplary embodiment.

Referring to FIG. 1, the audio system 1000-1 according to an exemplary embodiment includes a user terminal apparatus 100 (such as a cell phone) and an audio device 200.

The user terminal apparatus 100 may be various electronic devices. For example, the user terminal apparatus 100 may be implemented in various devices such as a digital camera, an MP3 player, a PMP, a smart phone, a cellular phone, smart glasses, a table PC, a smart watch, and the like.

The user terminal apparatus 100 transmits audio data to an external device (herein, the audio device). The user terminal apparatus 100 transmits color information extracted from image data to the external device (the audio device). The image data, which is image data prestored in the user terminal apparatus 100, may be image data generated by photographing a subject using the user terminal apparatus 100 or image data received and stored from another external device or a server.

The audio device 200 is a component that receives the audio data from the user terminal apparatus 100 and outputs the received audio data. In addition, the audio device 200 receives the color information extracted from the image data, from the user terminal apparatus 100. The audio device 200 outputs the received audio data to a speaker and turns on a lighting based on the received color information. The audio device 200 includes a component capable of turning on the lighting.

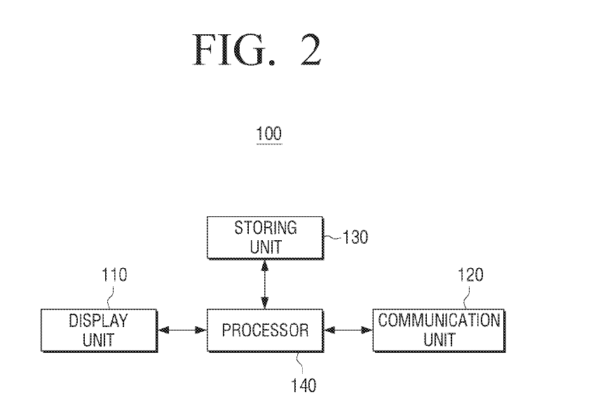

FIG. 2 is a block diagram illustrating a configuration of the user terminal apparatus 100 according to an exemplary embodiment.

Referring to FIG. 2, the user terminal apparatus 100 according to an exemplary embodiment includes a display unit 110, a storing unit 130, a communication unit 120, and a processor 140.

The display unit 110 is a component that displays at least one of a user interface configured of letters, icons, and the like, objects, user terminal apparatus information, a dynamic image, and a stationary image. Particularly, the display unit 110 displays the user interface including the object for transmitting the color information extracted from the audio data and the image data to the audio device 200. The image data may be at least one of an album image, a music video image, and an artist image related to the audio data.

Here, a kind of object is not limited. That is, the object may be at least one of an application icon, a contents icon, a thumbnail image, a folder icon, a widget, a list item, a menu, and a contents image. The application icon is an icon that executes an application included in the user terminal apparatus 100 when a corresponding image is selected. The contents icon is an icon that reproduces contents when a corresponding image is selected. The thumbnail image is an image displayed to see at a glance by reducing the image to a small size, and the folder icon is an icon that displays files within a folder when a corresponding image is selected. The widget is an icon that provides the user interface so that the application icon may be immediately executed without several steps of menu selection, the list item is a configuration that displays the files in a list form, and the menu image is a configuration that displays selectable menus.

The display unit 110 may be designed by various display panels. That is, the display unit 110 may be implemented by various display technologies such as an organic light emitting diode (OLED), a liquid crystal display (LCD) panel, a plasma display panel (PDP), a vacuum fluorescent display (VFD), a field emission display (FED), an electro luminescence display (ELD), and the like. The display panel is mainly formed of a light emission type, but a reflective display (E-ink, P-ink, Photonic Crystal) is not excluded. In addition, the display panel may be implemented as a flexible display, a transparent display, and the like.

The storing unit 130 stores a variety of information. Particularly, the storing unit 130 stores the audio data. The audio data may be received from an external device (not illustrated) different from the external device 200 described above, or received from the server. In addition, in the case in which the audio data is provided as a streaming, the storing unit 130 may temporarily store all or some of the audio data only for a short period of time.

In addition, the storing unit 130 may also store the image data described above. The image data may be generated by photographing the subject using the user terminal apparatus 100. Unlike this, the image data may be received from another external device or received from the server.

Besides, the storing unit 130 stores an operation system, an application, raw image data, processed image data, and the like.

The storing unit 130 may include a memory such as ROM or RAM, a hard disk drive (HDD), a blur-ray disk (BD), and the like. As the memory, an electrically erasable and programmable ROM (EEROM), or a non-volatile memory such as a non-volatile RAM may also be used, but a volatile memory such as a static RAM or a dynamic RAM may also be used. In the case of the hard disk drive, a small hard disk of 1.8 inches or less which may be mounted on the user terminal apparatus 100 may be applied.

The communication unit 120 is a component that communicates with the external device 200 or 300. Specifically, the communication unit 120 transmits the stored audio data to the external device to output the stored audio data from the external device.

In addition, the communication unit 120 transmits the extracted color information to the external device in order to turn on the lighting according to the color information extracted from the image data by the processor 140.

Unlike this, the communication unit 120 may also transmit a generated lighting turn-on signal to the external device according to the color information extracted from the image data by the processor 140.

In addition, the communication unit 120 may receive the audio data and/or the image data from another external device or the server.

The communication unit 120 may include at least one of a mobile communication module and a sub-communication module.

The mobile communication module (not illustrated) may be wirelessly connected to the external device using one or two or more antennas, according to a control of the processor 140. The mobile communication module transmits and receives wireless signals for a voice call, a video telephony, a short message service (SMS), a multimedia message service (MMS), and data communication with a cellular phone (not illustrated), a smart phone (not illustrated), a tablet PC, and another user terminal apparatus (not illustrated) that have phone numbers connectable with the user terminal apparatus 100.

The sub-communication module (not illustrated) may include at least one of a wireless LAN module (not illustrated) and a local area communication module (not illustrated). For example, the sub-communication module (not illustrated) may include only one of the wireless LAN module (not illustrated) and the local area communication module (not illustrated), and may include both the wireless LAN module (not illustrated) and the local area communication module (not illustrated).

The local area communication module may wirelessly perform local area communication between the user terminal apparatus 100 and the external device without an access point, according to the control of the processor 140. The local area communication may include at least one of Bluetooth, Bluetooth low energy, infrared data association (IrDA), Wi-Fi, ultra wideband (UWB), and near field communication (NFC).

The processor 140 may control a general operation of the user terminal apparatus 100. Particularly, the processor 140 controls the communication unit 120 so that the audio data is transmitted to the external device, extracts the color information from the image data, and controls the communication unit 120 so that the extracted color information is transmitted to the external device.

The color information means information on colors of some or all of a plurality of colors included in the image data. The color information may be dominant color information. The dominant color information is the dominant color information included in the image data. For example, if the image data is associated with a rape flower, the dominant color information may be yellow color information. As a method of determining the dominant color, if specific color among the overall colors included in the image data is included to exceed a preset ratio, or if specific color pixels of a preset number or more are included, the dominant color may be determined.

The processor 140 may be used together with a name such as a controlling unit, a central processing unit, a CPU, or the like.

The processor 140 controls the general operation of the user terminal apparatus 100 and a signal flow between internal components of the user terminal apparatus 100, and performs a function that processes data. In the case in which an input of a user or a set condition is satisfied, the processor 140 may execute an operation system (OS) and various applications that are stored in the storing unit 130.

Meanwhile, although not illustrated in the drawings, the user terminal apparatus 100 may further include a photographing unit (not illustrated).

The photographing unit (not illustrated) is a component that photographs the subject to generate the image data described above. That is, in the case in which the user photographs the subject using a camera included in the user terminal apparatus, the processor 140 extracts the color information from the generated image and transmits the extracted color information to the external apparatus.

To this end, the photographing unit (not illustrated) may include an image sensor (not illustrated), an analog front end (AFE; not illustrated), a timing generator (TG; not illustrated), a motor driver (not illustrated), and an image processing unit (not illustrated).

The image sensor is a component on which an image of the subject passing through a refracting optical system is focused. The image sensor includes a plurality of pixels which are arranged in a matrix form. Each of the plurality of pixels accumulates photo-charges according to incident light and outputs an image formed of the photo-charges as an electrical signal. The image sensor may be configured of a complementary metal oxide semiconductor (CMOS) or a charge coupled device (CCD).

The image sensor may include a photodiode (PD), a transmit transistor (TX), a reset transistor (RX), and a floating diffusion node (FD). The photodiode (PD) generates the photo-charges corresponding to an optical image of the subject and accumulates the generated photo-charges. The transmit transistor (TX) responds to a transmission signal and transmits the photo-charges generated by the photodiode (PD) to the floating diffusion node (FD). The reset transistor responds to a rest signal and discharges charges stored in the floating diffusion node (FD). Before the reset signal is applied, the charges stored in the floating diffusion node (FD) are output, and a correlated double sampling (CDS) image sensor performs a CDS process. In addition, an analog-to-digital converter converts an analog signal which is subjected to the CDS process into a digital signal.

The TG outputs a timing signal for reading out pixel data of the image sensor. The TG is controlled by the processor 140.

The AFE samples and digitalizes the electrical signal of the image of the subject output from the image sensor. The AFE is controlled by the processor 140.

However, the AFE and the TG as described above may also be designed by alternative components. Particularly, in the case in which the image sensor is implemented in a CMOS type, this component may be unnecessary.

The motor driver drives a focusing lens based on information calculated by reading out a phase difference pixel and focuses the focusing lens. However, in the case in which the user terminal apparatus 100 is implemented as a smart phone or a cellular phone, since the focusing may be processed in software without driving the lens for the focusing, the motor driver may not be included. In addition, the motor driver may drive at least one of a plurality of lenses and an image sensor included in a reflecting optical system and a refracting optical system in a direction which is perpendicular to an optical axis of a cata-dioptric system or an optical axis direction thereof to correct a hand shaking.

The image processing unit performs an image process of raw image data by the control of the processor 140 and records the image processed raw image data in the storing unit 130. In addition, the image processing unit transmits video processed data of the storing unit 130 to the display unit 110.

In the case in which an auto-focusing using the phase difference is performed, the image processing unit separates a signal for generating an image (a signal read out from a general pixel) and a signal for calculating the phase difference (a signal read out from the phase difference pixel) from each other among signals that are output from the image sensor and sampled by the AFE. This is to quickly perform the auto-focusing by generating an image such as a live view in parallel while quickly calculating the phase difference using the signal for calculating the phase difference.

However, the user terminal apparatus 100 according to the various exemplary embodiments are not limited to an auto-focusing technology using the phase difference pixel. That is, the user terminal apparatus 100 according to the various exemplary embodiments may further include a technical configuration capable of performing a contrast auto-focusing.

The image processing unit processes the raw image data and creates YCbCr data. A pixel defect of the raw image data is first corrected by a correction circuit (not illustrated). The correction circuit corrects the pixel defect with reference to a correction table in which an address of a pixel having defect is registered. The pixel matched to the above-mentioned address is corrected by pixels therearound.

The image processing unit includes an optical black (OB) clamp circuit (not illustrated) that determines a black level of the image. The image sensor is in an OB region and detects a signal average value of the OB region to determine the black level using a difference between the respective pixel values.

In addition, the image processing unit performs a sensitivity ratio adjustment which is different for each of the colors using a sensitivity ratio adjustment circuit (not illustrated).

In the case in which the stationary image is output, the image data is output through an output buffer after performing the sensitivity ratio adjustment. In this case, since the image is generated in an interlace scheme, a post-processing may not be immediately performed, while in the case in which the live view image is output, since the image is generated in a progressive scheme, the post-processing may be immediately performed.

In addition, since image processing unit performs a skip read out in which some pixel lines are read out and the remaining pixel lines are skipped, by a horizontal skip read out circuit (not illustrated), the number of pixels of the raw image is decreased.

The image processing unit adjusts a white balance (WB) for the image data using a WB adjustment circuit (not illustrated).

In addition, the image processing unit performs a gamma correction for the image data. By the gamma correction, a gray scale conversion suited to an output of the display unit 110 is performed.

In addition, the image processing unit generates a typical color image signal of three colors per one pixel from a Bayer signal of one color per one pixel, using a color interpolation circuit (not illustrated).

In addition, the image processing unit performs a color space conversion suited to the output and a color correction, using a color conversion/color correction circuit (not illustrated). If necessary, the image processing unit may use a look up table (LUT). After performing the color conversion/color correction, the image data becomes YCbCr data.

The image processing unit adjusts a size by converting resolution using a resolution conversion circuit (not illustrated).

In addition, the image processing unit performs a space filtering for the image data using a space filter circuit (not illustrated).

In addition, the image processing unit performs a skip read out for a Cb/Cr signal using a Cb/Cr skip read out circuit (not illustrated) to be converted into an image data of YCbCr of 4:2:2.

In the case of the stationary image, the read out may be performed in the interlace scheme, and in this case, since there are no pixel lines which are adjacent to each other, a direct color interpolation may not be processed. Therefore, after a pre-processing is completed, the stationary image is first stored in the progressive form in the storing unit 130 through the output buffer by adjusting the order of pixel lines. The above-mentioned image data is again read and is input to the image processing unit through an input buffer.

However, in the case of the stationary image, the exemplary embodiment is limited to the interlace scheme, but may also be implemented to be read out in the progressive scheme.

Meanwhile, in the case of the stationary image, there is a need to generate a preview image that shows the stationary image to be small after being photographed, or a thumbnail image. This omits and creates data of some pixels such as the skip read out.

The image processing unit interpolates a portion of the phase difference pixel into a general pixel value using an AF signal interpolation circuit (not illustrated). The phase difference pixel is located between the general pixels. Accordingly, if the portion of the phase difference pixel is used as it is, deterioration in resolution may occur. Therefore, the interpolation is performed using the general pixels around the phase difference pixel.

A JPEG codec of the image processing unit compresses the YCbCr data. In addition, the compressed image data is recoded in the storing unit 130. Thereby, a process of generating an image is terminated.

In addition, the processor 140 may detect audio pattern information from the audio data and control the communication unit 120 so that the detected audio pattern information is transmitted to the external device to turn on the lighting according to the detected audio pattern information.

Unlike this, the processor 140 may also control the communication unit 120 so that meta data of the audio data is transmitted to the external device.

Here, the meta data of the audio data may include at least one of music genre information, artist information, beat information, and language information of the audio data.

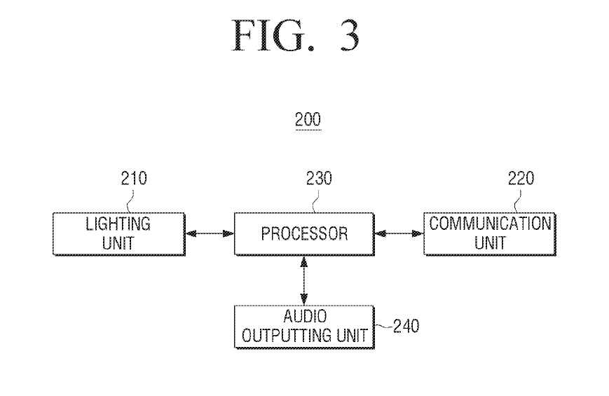

FIG. 3 is a block diagram illustrating a configuration of an external device according to an exemplary embodiment.

In the exemplary embodiment of FIG. 3, the external device may be the audio device 200.

As illustrated in FIG. 3, the audio device 200 includes a lighting unit 210, a communication unit 220, a processor 230, and an audio outputting unit 240. The device 200 may be a light and sound producing device

The lighting unit 210 is a component that turns on the lighting according to the received color information. The lighting unit may include at least one light emitting diode (LED) and a circuit component capable of turning on the light emitting diode. The process 230 controls a turn-on signal for the lighting unit 210. The LED may be an RGB (Red, Green, Blue) LED. The lighting unit 210 may be part of the audio device 200, such as audio speakers.

The communication unit 220, which is a component communicating with the user terminal apparatus 100, receives the audio data and the color information of the image data from the user terminal apparatus 100. Since a technical configuration of the communication unit 220 is similar to that of the communication unit 120 of the user terminal apparatus 100, a detailed description thereof will be omitted.

The audio outputting unit 240 is a component that outputs the audio data. The audio outputting unit 240 performs a signal processing for the received audio data and outputs the audio data through the speaker.

The audio outputting unit 240 separates audio signals of a plurality of channels using a pulse width modulation (PWM) integrated circuit (IC) to be converted into a PWM signal and switches the converted PWM signal to extract an audio signal of a first channel, an audio signal of a second channel, and the like, respectively. In addition, the audio outputting unit 240 transmits the respective audio signals to a plurality of speakers.

The speaker (not illustrated) is a component that outputs the received audio signal. Only one speaker may also be provided, but a plurality of speakers may be provided. For example, a three-channel audio speaker may include a left-front speaker, a center speaker, and a right-front speaker. In addition, the audio speaker may further include a sub-woofer that outputs an audio signal of a sub-woofer channel of a base tone. A 5.1-channel audio speaker may include a sub-woofer, a left-rear speaker, a left-front speaker, a right-front speaker, a right-rear speaker, and a center speaker.

The processor 230 controls a general operation of the audio device 200. Particularly, the processor 230 controls the communication unit 220 so that the audio data is received and controls the audio outputting unit 240 so that the received audio data is output. In addition, the processor 230 controls the lighting unit 210 so that the lighting of the audio device 200 is turned on according to the color information. Unlike this, the processor 230 may also receive a lighting control signal according to the color information from the user terminal apparatus 100.

Here, as described above, the color information may be the dominant color information extracted from the image data by the user terminal apparatus 100. In addition, the processor 230 may control the lighting unit 210 so that the lighting corresponding to the received dominant color information is turned on. For example, in the case in which the received dominant color information includes yellow color information, the processor 230 may control the lighting unit 210 so that a yellow color lighting is turned on.

In addition, the processor 230 may control the lighting unit 210 so that the lighting corresponding to at least one of a music genre, composition of tone, a mood, an artist, a beat, and a used language (audio characteristic information) of the received audio data is turned on. For example, in the case in which the received audio data is rock music, the processor 230 may control the lighting unit 210 so that a red color lighting is turned on. In addition, the processor 230 may analyze the received audio data to detect beat information and determine a turn-on pattern of the lighting according to the detected beat information to turn on the lighting. For example, the processor 230 may extract a rhythm of a percussion instrument included in the audio data and turn on the lighting corresponding to the rhythm.

The processor 230 may also obtain the audio characteristic information described above by analyzing the audio data, but may also receive the audio characteristic information related to the audio data from the user terminal apparatus 100 or other external devices. For example, in the case in which the processor 230 receives the audio data, the processor 230 may inquire about an audio pattern of the audio data of an external server and receive the meta data related to the audio data from the server. The received meta data may include at least one of a music genre, composition of tone, a mood, an artist, a beat, and a used language of the audio data as described above, and the processor 230 may control the lighting unit 210 so that the lighting is turned on using the above-mentioned audio characteristic information.

In addition, the communication unit 220 may further receive the pattern information of the audio data from the user terminal apparatus 100. In this case, the processor 230 may control the lighting unit 210 so that the lighting corresponding to the received pattern information and color information is turned on.

The processor 230 may be used together with a name such as a controlling unit, a central processing unit, a CPU, or the like.

The processor 230 controls the general operation of the audio device 200 and a signal flow between internal components of the audio device 200, and performs a function that processes data. In the case in which an input of a user or a set condition is satisfied, the processor 230 may execute an operation system (OS) and various applications that are stored in a storing unit (not illustrated).

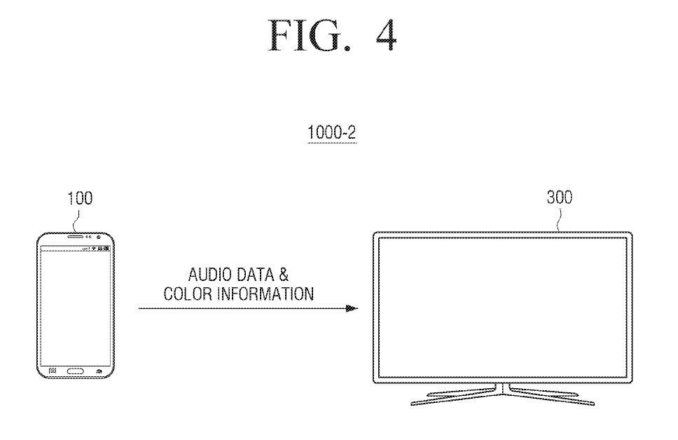

FIG. 4 is a schematic diagram of an audio system 1000-2 according to another exemplary embodiment.

Referring to FIG. 4, the audio system 1000-2 according to another exemplary embodiment includes the user terminal apparatus 100, such as a smart phone, and a display apparatus 300, such as a TV.

The user terminal apparatus 100 is a component that transmits audio data and color information of image data to the display apparatus 300. Since the user terminal apparatus 100 has been described above, an overlapped description will be omitted.

In the present exemplary embodiment, the external device described above may be implemented by the display apparatus 300. As described above, the display apparatus 300 receives the audio data and the color information of the image data from the user terminal apparatus 100 and outputs the audio data based on the color information.

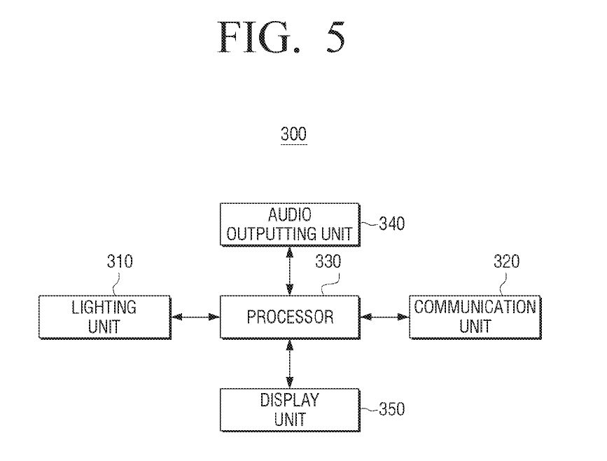

FIG. 5 is a block diagram illustrating a configuration of an external device according to another exemplary embodiment.

Referring to FIG. 5, the external device according to another exemplary embodiment further includes a display unit 350 in addition to the lighting unit 310, a communication unit 320, a processor 330, and an audio outputting unit 340.

Since the lighting unit 310, the communication unit 320, the processor 330, and the audio outputting unit 340 have the same configuration and operation as those of the lighting unit 210, the communication unit 220, the processor 230, and the audio outputting unit 240 described above except for contents which will be newly described below, an overlapped description will be omitted.

The display unit 350 is a component that displays information. Particularly, the display unit 350 displays an image corresponding to color information received from the user terminal apparatus 100.

The displayed image may include at least one of a user interface configured of letters, icons, and the like, objects, user terminal apparatus information, a dynamic image, and a stationary image.

The display unit 350 may be designed by various display panels. That is, the display unit 350 may be implemented by various display technologies such as an organic light emitting diode (OLED), a liquid crystal display (LCD) panel, a plasma display panel (PDP), a vacuum fluorescent display (VFD), a field emission display (FED), an electro luminescence display (ELD), and the like. The display panel is mainly formed of a light emission type, but a reflective display (E-ink, P-ink, Photonic Crystal) is not excluded. In addition, the display panel may be implemented as a flexible display, a transparent display, and the like.

The processor 330 controls the display unit 350 so that an image corresponding to the received color information is displayed. For example, in the case in which the received color information includes yellow color, the processor 330 may display the image including the yellow color.

In addition, the processor 330 may search an image related to the received audio data and display the searched image. In this case, the processor 330 may control the communication unit 320 so that an image related to the audio data is received from an external Internet server by recognizing a pattern of the received audio data and requesting identification to the external Internet server. For example, in the case in which the audio data is a music of a specific artist, the processor 330 may display a record jacket, a music video, or the like including the corresponding music.

In addition, the processor 330 may control the communication unit 320 so that the pattern information of the audio data is received, and the processor 330 controls the display unit 350 so that an image corresponding to the pattern information of the received audio data and the color information is displayed. The pattern information of the audio data may be beat information of the audio data. In this case, the processor 330 may display an image corresponding to the color information according to a beat of the audio data. In addition, the processor 330 may search a plurality of images from Internet and may also display the plurality of images while changing the plurality of images according to the beat.

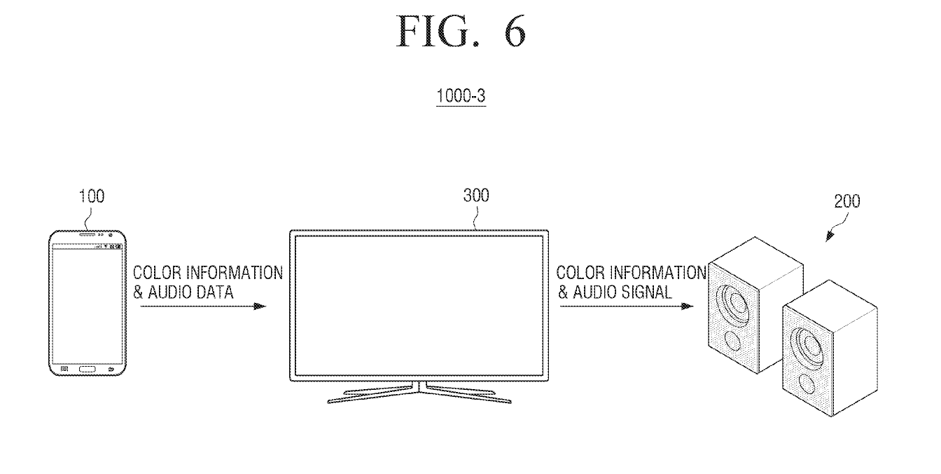

FIG. 6 is a schematic diagram of an audio system 1000-3 according to still another exemplary embodiment.

Referring to FIG. 6, the audio system 1000-3 according to still another exemplary embodiment may include the user terminal apparatus 100, the display apparatus 300, and the audio device 200.

The respective components are operated in the same scheme as that described above except for contents which will be newly described below.

The user terminal apparatus 100 may transmit the color information of the image and the audio data to the display apparatus 300. The display apparatus 300 processes the audio data and extracts the audio signal. In addition, the display apparatus 300 transmits the audio signal and the color information to the audio device 200.

The audio device 200 turns on the lighting according to the color information while outputting the received audio signal.

However, unlike this, the display apparatus 300 may also generate an audio turn-on signal according to the color information and may also transmit the generated audio turn-on signal to the audio device 200. In addition, the display apparatus 300 may also perform a signal processing for the audio data, transmit the signal processed audio data to the audio device 200, and output the signal processed audio data through a speaker included in the display apparatus 300.

Further, as described above, the display apparatus 300 may also display an image using the display unit or turn on the lighting included in the display apparatus 300 according to the color information.

Meanwhile, although not mentioned in the exemplary embodiments described above, the user terminal apparatus 100 may further include a means for sensing other use environments.

As one exemplary embodiment, the user terminal apparatus 100 may further include an illuminance sensor (not illustrated) to detect an amount of light around the user terminal apparatus 100. A signal for the detected amount of light is transmitted to the processor 140, and the processor 140 controls the communication unit 120 so that at least one of sensed illuminance information, color information corresponding to the illuminance information, and a lighting control signal corresponding to the illuminance information is transmitted to the external device. Instead of the illuminance sensor, the photographing unit described above may also be used.

The external device receives at least one of the sensed illuminance information, the color information corresponding to the illuminance information, and the lighting control signal corresponding to the illuminance information and turns on the lighting based on the received information.

As another exemplary embodiment, the user terminal apparatus 100 may transmit time information to the external device. The time information is obtained by a RTC circuit included in the user terminal apparatus 100. The user terminal apparatus 100 may also transmit at least one of color information corresponding to the time information and a lighting control signal corresponding to the time information to the external device, instead of the time information.

The external device receives at least one of the time information, the color information corresponding to the time information, and the lighting control signal corresponding to the time information and turns on the lighting based on the received information.

The user terminal apparatus 100, the audio device 200, and the display apparatus 300 described above further include a configuration of a general electronic device such as a power supply unit, in addition to the technical configurations described above.

Hereinafter, a method for outputting audio according to various exemplary embodiments will be described.

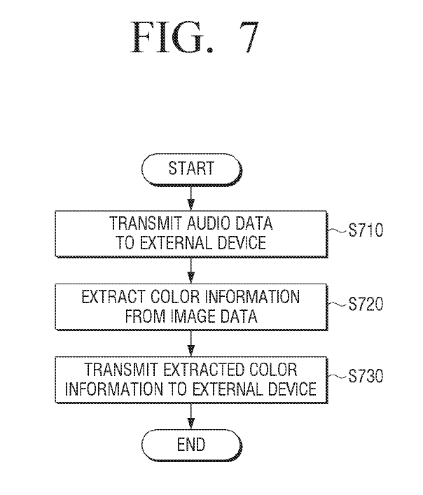

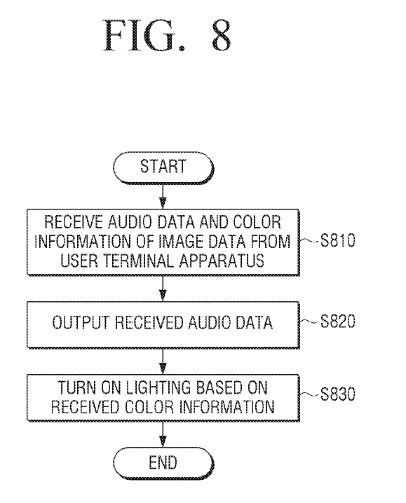

FIGS. 7 and 8 are flow charts of a method for outputting audio according to an exemplary embodiment.

Referring to FIG. 7, the method for outputting audio according to an exemplary embodiment includes an operation (S710) of transmitting audio data to an external device, an operation (S720) of extracting color information from image data, and an operation (S730) of transmitting the extracted color information to the external device.

Here, the operation of extracting the color information from the image data may include an operation of extracting dominant color information from the image data, and the operation of transmitting the extracted color information to the external device may include an operation of transmitting the extracted dominant color information to the external device in order to turn on a lighting according to the extracted dominant color information.

In addition, the method for outputting audio may further include an operation of photographing a subject to generate the image data.

In addition, the image data may be at least one of an album image, a music video image, and an artist image related to the audio data.

In addition, the method for outputting audio may further include an operation of transmitting meta data of the audio data to the external device.

The meta data of the audio data may include at least one of music genre information, artist information, beat information, and language information of the audio data.

In addition, the external device may be an audio device or a display apparatus.

Referring to FIG. 8, a method for outputting audio according to another exemplary embodiment includes an operation (S810) of receiving audio data and color information of image data from a user terminal apparatus, an operation (S820) of outputting the received audio data, and an operation (S830) of turning on a lighting based on the received color information.

Here, the color information is dominant color information extracted from image data by the user terminal apparatus, and in the operation of turning on the lighting, the lighting corresponding to the received dominant color information may be turned on.

In addition, in the operation of turning on the lighting, the lighting corresponding to at least one of a music genre, an artist, a beat, and a language of the received audio data may be turned on.

In addition, the method for outputting audio may further include an operation of receiving pattern information of the audio data, and in the operation of turning on the lighting, the lighting corresponding to the received pattern information and color information may be turned on.

In addition, the method for outputting audio may further include an operation of displaying an image corresponding to the received color information.

Meanwhile, although the exemplary embodiments described above describe the case in which the audio device is directly connected to the user terminal apparatus to receive the audio data and the color information, this is merely one exemplary embodiment. The audio device may be connected to the user terminal apparatus through an access point (AP) and may be implemented as a network speaker that receives the audio data and the color information from the user terminal apparatus.

Specifically, in the case in which the user terminal apparatus is connected to the AP and the audio device is connected to the AP, the user terminal apparatus and the audio device belong to the same wireless network environment as each other. Here, the user terminal apparatus may generate preset ID information for a wireless speaker and transmit the generated ID information to the AP. In addition, the AP transmits the preset ID information to the audio device through the wireless network. In the case in which the audio device receives the preset ID information, the audio device may perform a paring operation with the user terminal apparatus based on the preset ID information. In the case in which the paring operation is performed, the user terminal apparatus may transmit the received audio data and the extracted color information to the audio device.

The paring operation as described above may be performed only in the case in which the user terminal apparatus and the audio device are firstly connected to the same network, and thereafter, the paring operation may be automatically performed.

Meanwhile, the method for outputting audio described above may be stored in a non-transitory computer-readable record medium in a program form on a computer. Here, the non-transitory computer-readable medium does not mean a medium storing data for a short period such as a register, a cache, or the like, but means an electronic device-readable medium that semi-permanently stores the data. For example, the non-transitory computer-readable medium may be CD, DVD, a hard disc, Blu-ray disc, USB, a memory card, ROM, or the like.

In addition, the method for outputting audio described above may be provided so as to be embedded in a hardware IC chip in an embedded software form, and may be included as a partial configuration of the user terminal apparatus 100, the audio device 200, and the display apparatus 300 described above.

Although the exemplary embodiments have been shown and described, it should be understood that the embodiments are not limited to the disclosed embodiments and may be variously changed without departing from the spirit and the scope thereof. Accordingly, such modifications, additions and substitutions should also be understood to fall within the scope thereof.

What is claimed is:

1. A user terminal apparatus, comprising:
a display unit;
a storing unit configured to store audio data;
a communication unit configured to transmit stored audio data to an external device to output the stored audio data from the external device; and
a processor configured to extract color information from image data and control the communication unit to transmit extracted color information to the external device to turn on lighting according to the extracted color information.

2. The user terminal apparatus as claimed in claim 1, wherein the processor extracts dominant color information from the image data and controls the communication unit to transmit extracted dominant color information to the external device to turn on the lighting according to the extracted dominant color information.

3. The user terminal apparatus as claimed in claim 1, further comprising a photographing unit configured to photograph a subject to generate the image data.

4. The user terminal apparatus as claimed in claim 1, wherein the image data is at least one of an album image, a music video image, and an artist image related to the audio data.

5. The user terminal apparatus as claimed in claim 1, wherein the processor detects audio pattern information from the audio data and controls the communication unit to transmit detected audio pattern information to the external device to turn on the lighting according to the detected audio pattern information.

6. The user terminal apparatus as claimed in claim 1, wherein the processor controls the communication unit to transmit meta data of the audio data to the external device.

7. The user terminal apparatus as claimed in claim 6, wherein the meta data of the audio data includes at least one of music genre information, artist information, beat information, and language information of the audio data.

8. The user terminal apparatus as claimed in claim 1, wherein the external device comprises one of an audio device and a display apparatus.

9. An external device, comprising:
a lighting unit;
a communication unit configured to receive audio data and color information of image data from a user terminal apparatus;
an audio outputting unit configured to output received audio data; and
a processor configured to control the lighting unit to turn on lighting on based on received color information.

10. The external device as claimed in claim 9, wherein the color information is dominant color information extracted from the image data by the user terminal apparatus, and
the processor controls the lighting unit to turn on the lighting corresponding to received dominant color information.

11. The external device as claimed in claim 9, wherein the processor controls the lighting unit to turn on lighting corresponding to at least one of a music genre, an artist, a beat, and a language of the received audio data.

12. The external device as claimed in claim 9, wherein the communication unit further receives pattern information of the audio data, and the processor controls the lighting unit to turn on lighting corresponding to the received pattern information and color information.

13. The external device as claimed in claim 9, further comprising a display unit, wherein the processor controls the display unit to display an image corresponding to the received color information.

14. The external device as claimed in claim 13, wherein the communication unit further receives pattern information of the audio data, and the processor controls the display unit to display an image corresponding to the pattern information of the received audio data and the color information.

15. A method for outputting audio, the method comprising:
transmitting audio data to an external device to output the audio data from the external device;
extracting color information from image data; and
transmitting extracted color information to the external device to turn on lighting according to the extracted color information.

16. The method as claimed in claim 15, wherein the extracting of the color information from the image data includes extracting dominant color information from the image data, and
the transmitting of the extracted color information to the external device includes transmitting extracted dominant color information to the external device to turn on the lighting according to the extracted dominant color information.

17. The method as claimed in claim 15, further comprising photographing a subject to generate the image data.

18. The method as claimed in claim 15, wherein the image data is at least one of an album image, a music video image, and an artist image related to the audio data.

19. A method for outputting audio, the method comprising:
receiving audio data and color information of image data from a user terminal apparatus;
outputting received audio data; and
turning on lighting based on received color information.

20. The method as claimed in claim 19, wherein the color information is dominant color information extracted from the image data by the user terminal apparatus, and
in the turning on of the lighting, lighting corresponding to received dominant color information is turned on.
